(19) United States
(12) Patent Application Publication
(10) Pub. No.: US 2025/0290780 A1
(43) Pub. Date: Sep. 18, 2025

(54) DEVICE FOR ARRANGING ON A FLUID-CONDUCTING LINE AND FOR ATTACHING A FLOWMETER, AND METHOD FOR DETECTING A MEASUREMENT VARIABLE OF THE FLUID BEING CONDUCTED BY A LINE

(71) Applicants: Sartorius Stedim Biotech GmbH, Göttingen (DE); Levitronix GmbH, Zürich (CH)

(72) Inventors: Matthias Bode, Krebeck-Renshausen (DE); Norbert Aue, Bovenden (DE); Edgar Hoffmann, Hofstetten (DE); Maciej Bober, Penzing (DE)

(73) Assignees: Sartorius Stedim Biotech GmbH, Göttingen (DE); Levitronix GmbH, Zürich (CH)

(21) Appl. No.: 18/862,482

(22) PCT Filed: May 3, 2023
(86) PCT No.: PCT/EP2023/061699

§ 371 Date: Nov. 1, 2024

(30) Foreign Application Priority Data
May 4, 2022 (EP) 22171520.4

(51) Int. Cl. G01F 1/66; G01F 15/18

(52) U.S. Cl. CPC G01F 1/662; G01F 15/185

(57) ABSTRACT

A device for arranging on a fluid-conducting line and for attaching a flowmeter, in particular an ultrasonic flowmeter, for detecting a measurement variable of the fluid conducted by the line has a first and a second connection, and a measurement region arranged between the first connection and the second connection. The first connection, the measurement region, and the second connection define a flow path for the fluid through the device, and a flow-influencing element arranged in and/or on the flow path is configured to cause fluid flowing into the device via the first connection with a substantially laminar flow to have a substantially turbulent flow in the measurement region.

The present invention relates to a device for arranging on a fluid-conducting line and for attaching a flowmeter and a method for detecting a measurement variable of the fluid conducted by a line.

In a large number of methods in the automation of industrial or laboratory processes, flow measurements are carried out in pipe, tube, and hose systems to monitor the processes. In-line flow measuring devices and clamp-on flow measuring devices, among others, are used for flow measurements. In-line flow measuring devices have measuring sensors installed in the flow profile of the fluid or medium to be measured, whereas clamp-on flow measuring devices are placed and clamped from the outside onto a line, pipe, or hose that conducts the fluid or medium.

Clamp-on flow measuring devices are also known in which a device is installed in a plastic hose conducting the fluid or medium in such a manner that the fluid or medium flows through the device. A flow measuring device is fastened to this device, which inputs a suitable input signal, e.g. an ultrasonic signal, into the device built into the plastic hose and performs the flow measurement using an output signal received via the device.

The present invention is based on the object of providing a device for arranging on a fluid-conducting line and for attaching a flowmeter, which makes it possible to improve the accuracy of a flow measurement. Furthermore, it is the object of the invention to propose a method for detecting a measurement variable of the fluid conducted by a line, which enables the measurement variable to be detected as accurately as possible.

This object is achieved by the subject matter of the independent claims. Preferred embodiments are achieved in the dependent claims.

A first aspect relates to a device for arranging on a fluid-conducting line and for attaching a flowmeter, in particular an ultrasonic flowmeter, for detecting a measurement variable of the fluid conducted by the line, wherein the device has:
a first and a second connection, by means of which the device can be connected to the fluid-conducting line,
a measurement region which is arranged between the first connection and the second connection and which can be coupled to the flowmeter in order to detect the measurement variable, wherein the first connection, the measurement region and the second connection define a flow path for the fluid through the device,
a flow-influencing element which is arranged in and/or on the flow path and which is arranged in front of the measurement region in a provided flow direction of the fluid along the flow path and at a distance therefrom, wherein the flow-influencing element is integrally formed with the first connection or the second connection, and
wherein the flow-influencing element is designed such that the fluid flowing into the device via the first connection, said fluid flowing into the device with a substantially laminar flow, has a substantially turbulent flow in the measurement region.

Advantageously, the provision of the flow-influencing element makes it possible to improve the measurement accuracy of the detected measurement variable even at a low flow velocity of the fluid and/or at a low volume flow of the fluid along the flow path. Preferably, the bandwidth of the flow velocity of the fluid and/or the bandwidth of the volume flow of the fluid, in which a more accurate detection of the measurement variable is possible, can thus be increased. The bandwidth can be understood as a region that is limited by a lower value at the bottom and an upper value at the top. For example, the bandwidth of flow velocities can be limited downwards by a lower flow velocity value and upwards by an upper flow velocity value. The bandwidth of volume flows can also be limited downwards by a lower volume flow value and upwards by an upper volume flow value. In particular, it was recognized that the presence of a substantially turbulent flow in the measurement region, rather than a laminar flow, can improve the measurement accuracy. Without explicitly committing to a specific theory, it is assumed that, due to the presence of a turbulent flow, individual layers of the fluid or medium, when viewed across the cross-section of the flow path, have similar flow velocities in the direction of the flow path, thus improving the measurement accuracy. In other words, the fluid or medium has substantially similar or constant flow velocities across the cross-section of the flow path. In contrast, in a laminar flow, the flow velocity decreases from the center of the cross-section of the flow path towards the outer region of the cross-section of the flow path, so that a corresponding flow velocity profile across the cross-section is substantially parabolic. The cross-section of the flow path may in particular correspond to a planar section through the device at an angle of 90° to the longitudinal axis or (main) flow direction of the fluid through the device and can refer to the region enclosed by the device, in particular the internal cross-section of the device.

In particular, the Reynolds number can be used to differentiate between laminar and turbulent flow. Assuming an idealized pipe flow, it is assumed that the critical Reynolds number, at which a change from laminar to turbulent flow is to be expected, is approximately 2300. Since the Reynolds number is influenced by the density of the fluid, the average flow velocity of the fluid relative to the device, the characteristic length of the device or the flow path and the dynamic viscosity of the fluid, the position and size of the flow-influencing element must be adapted to the application, e.g. a to be expected viscosity of the fluid or flow velocities of the fluid, wherein the determination of corresponding position and size relationships of the flow-influencing element can be carried out by a computer-aided simulation. Preferably, the position and design of the flow-influencing element are such that a Reynolds number of at least 2300 is achieved in front of the measurement region.

Advantageously, the one-piece design of the flow-influencing element with the first or second connection allows the flow-influencing element to be arranged at a fixed distance in relation to the measurement region. Surprisingly, it has been found that a fixed positioning of the flow-influencing element in relation to the measurement region leads to a reliable formation of a suitable flow profile or to a turbulent flow in the measurement region, in particular over a large region of flow velocities of the fluid and/or large temperature ranges and/or different viscosities of the fluid. In particular, it was recognized that even with increasing flow velocities of the fluid and with different viscosities, a turbulent flow profile is present in the measurement region. This makes the device easy to use, as the distance of the flow-influencing element in relation to the measurement region does not need to be adjusted, while at the same time ensuring a suitable flow profile in the measurement region. In particular, “one-piece” means that the flow-influencing element is formed integrally with the first or second connection and/or that the flow-influencing element is firmly or monolithically connected to the first or second connection. The one-piece design also makes it easy to calibrate the flowmeter.

Preferably, the device can be provided for a usable bandwidth of flow velocities and/or a usable bandwidth of volume flows at which the measurement variable is detected. In particular, it may be intended to detect the measured variable exclusively within the usable bandwidth. Preferably, the flow-influencing element is designed such that the fluid has a turbulent flow in the measurement region starting at a volume flow of approximately 10% to 20% of the upper value of the usable bandwidth, e.g. a maximum volume flow that limits the usable bandwidth of volume flows upwards.

Preferably, the usable bandwidth of volume flows can be approximately >0 ml/min to 4000 ml/min, particularly preferably from approximately >0 ml/min to 5000 ml/min.

Preferably, the device can be used for fluids with a (dynamic) viscosity of 0.6 mPa-s (cP) to 4.2 mPas (cP), preferably from 0.8 mPa·s (cP) to 4.0 mPa·s (cP).

In particular, the first and second connections as well as the measurement region arranged between the first and second connections can have a channel, or flow channel, which defines the flow path and through which the fluid or medium flows. As a fluid-conducting line which can be connected to the first and second connection, pipes or hoses, for example made of plastic, can be provided. For example, to attach the device to the line, it may be provided to disconnect the line in such a manner that a first open end of the line is connected to the first connection and a second open end of the line is connected to the second connection so that the device connects the first open end and the second open end of the line.

Preferably, the flow path or channel is formed in an elongated manner and runs substantially rectilinear. In particular, it may be provided that the flow path is not curved or bent, for example does not have a 90° bend, so that the main direction of flow of the fluid or medium through the device is substantially constant.

The fluid or medium can in particular be liquid, and the fluid or medium can also have solid components, such as particles or cell components. However, the invention is not limited to fluids in liquid form.

Preferably, the flow-influencing element is designed such that the conversion point from laminar to turbulent flow is in front of the measurement region when viewed in the direction of flow. Advantageously, a turbulent flow can thus be present in the entire measurement region.

Preferably, the flowmeter can couple an input signal, e.g. an ultrasonic signal, into the measurement region and receive an output signal based on the input signal via the measurement region. Using the input and output signal, the flowmeter can detect a measurement variable relevant for the flow measurement, e.g. a volume flow or mass flow measurement. In particular, the flowmeter can be a clamp-on flowmeter.

Preferably, the first and second connections can have at least in sections a substantially circular (internal) cross-section along the flow path. Furthermore, the measurement region can have at least in sections a substantially rectangular, in particular square, (internal) cross-section or preferably a hexagonal (internal) cross-section along the flow path.

Preferably, the flow-influencing element can be designed as a cross-sectional constriction of the flow path, wherein the cross-sectional area of the flow path immediately in front of and after the flow-influencing element is larger than the (smallest) cross-sectional area of the flow path of the flow-influencing element. Preferably, the cross-sectional area of the flow path of the flow-influencing element can be approximately 6% to 20%, preferably approximately 8% to 15%, in particular approximately 8.5% to 12%, less than the cross-sectional area of the flow path immediately in front of and after the flow-influencing element. Furthermore, the flow path can be characterized by a sharp transition to and from the flow-influencing element.

Advantageously, a change from laminar flow to turbulent flow can be achieved with a corresponding reduction in the cross-sectional area of the flow path by the flow-influencing element.

Preferably, the flow-influencing element can be designed as a protrusion extending into the flow path from a wall surrounding the flow path, which is formed by the first and second connections and the measurement region.

In particular, the flow-influencing element can be designed as a substantially ring-shaped constriction, which is preferably structured. For example, the flow-influencing element can be fully formed on the inside of the wall surrounding the flow path and aligned transversely to the longitudinal direction of the device or flow direction. The constriction can also be structured in the shape of a crown cork. Furthermore, the dimension of the flow-influencing element in the flow direction can be smaller than or equal to the dimension with which the flow-influencing element projects from the wall into the flow path.

Preferably, the cross-sectional area of the flow path of the flow-influencing element can be at least approximately 30%, preferably at least approximately 40%, smaller than the cross-sectional area of the flow path of the first connection at the beginning of the flow path. Furthermore, the cross-sectional area of the flow path of the flow-influencing element can be at most approximately 70%, preferably at most approximately 65%, smaller than the cross-sectional area of the flow path of the first connection at the beginning of the flow path.

Preferably, the first and/or second connection can each have a channel which forms at least part of the flow path, wherein the fluid can flow into or out of the device at a first end of the channel and the measurement region is arranged at a second end of the channel. Preferably, the first connection through which the fluid or medium flows into the device has the flow-influencing element. Furthermore, the second connection may also have a further flow-influencing element. Advantageously, this eliminates the need to take into account the direction of flow of the fluid when installing the device in a line. Preferably, the further flow-influencing element can be formed in one piece with the second connection.

In particular, the channel of the first and second connections may have a substantially circular (internal) cross-section, wherein the cross-section tapers starting from the first end of the channel in the direction of the flow-influencing element, and wherein preferably the cross-section of the channel widens starting from the flow-influencing element in the direction of the second end of the channel.

Furthermore, the first and/or second connection can be detachably connected to the measurement region to enable a modular design of the device. In particular, the first and second connections and the measurement region can each be designed as elongated hollow bodies that can be detachably connected to one another. Furthermore, the first and second connections can be designed to be rotationally symmetrical with respect to their respective longitudinal axis, which runs substantially parallel to the main direction of flow of the medium through the device.

Preferably, the channel of the first or second connection can be conically tapered starting from the first end of the channel in the direction of the flow-influencing element. Advantageously, the conical design of the channel allows the flow velocity of the fluid to increase in front of the flow-influencing element, which increases the effect of the flow-influencing element. Furthermore, the cross-sectional area of the flow path at the first end of the channel can be larger than the cross-sectional area of the flow path of the flow-influencing element.

Furthermore, the channel of the first or second connection can be conically tapered and taper starting from the second end of the channel in the direction of the flow-influencing element. Accordingly, the channel tapers conically towards the flow-influencing element from both directions. Furthermore, the cross-sectional area of the flow path at the first and/or second end of the channel can be larger than the cross-sectional area of the flow path of the flow-influencing element. Advantageously, the conical design of the channel allows the first or second connection to be easily produced, in particular if the first or second connection is produced by an injection molding process.

Furthermore, the first and/or second connection and the measurement region can be produced using an injection molding process and made from a plastic material. Advantageously, due to the tapered shape of the first and/or second connection from the respective ends of the connections towards the flow-influencing element, the first and/or second connection can be easily produced by the injection molding process. Alternatively, the first and/or second connection and/or measurement region can be produced using a 3D printing method.

Preferably, the first and/or second connection can be designed such that the fluid-conducting line can be arranged in a self-locking manner on the first connection and/or the second connection, wherein the first and/or the second connection can be designed in particular as a hose olive or hose spike.

Furthermore, the measurement region may have a channel that forms part of the flow path, at least in sections. In this case, the channel can extend between two openings, wherein a first connection receptacle for the first connection is provided at a first opening of the two openings and a second connection receptacle for the second connection is provided at a second opening of the two openings. The device thus has a modular structure and can be assembled by connecting the first connection, preferably detachably, to the first connection receptacle and connecting the second connection, preferably detachably, to the second connection receptacle, so that the measurement region is located between the first connection and the second connection.

In particular, the first and second connection receptacles can be designed to be conically shaped in the longitudinal direction of the device or the measurement region, and it may further be provided that the first and second connections have a complementary conical shape and are inserted into the corresponding connection receptacle in order to be connected to the measurement region.

Preferably, it can be provided that the first and/or second connection can each be secured to the measurement region with a securing element. The securing element, for example a union nut or a lock, is used to detachably fasten the first and/or second connection to the measurement region.

Advantageously, the modular design allows the device to be adapted to the specific application. Thus, depending on the application, the device can be configured with connections that have a desired flow-influencing element.

Preferably, it can be provided that the measurement region has at least two contact surfaces which extend at least in sections along the flow path, wherein the contact surfaces can be coupled to the flowmeter, which is preferably designed as a clamp-on flowmeter. In particular, the contact surfaces may be arranged on the outside of the measurement region, wherein the normal vector of the contact surfaces is preferably substantially perpendicular to the longitudinal axis of the device or flow direction. For coupling the flowmeter and performing the flow measurement, it may be provided that corresponding signal converters or sensors of the flowmeter contact the contact surfaces, preferably over a large area, in order to input a signal, e.g. an ultrasonic signal, into the device, wherein the signal is detected by the flowmeter after passing through the flow path. The measurement variable can be determined by comparing the input signal with the detected signal. Preferably, the at least two contact surfaces are arranged opposite one another with respect to the flow path. Preferably, the measurement region has six contact surfaces, which are arranged such that they are arranged substantially hexagonally when viewed in the flow direction.

Preferably, the measurement region can be spaced from the flow-influencing element in the direction of flow of the fluid through the device between 5 and 60 times the diameter of the flow-influencing element. The diameter is understood to be the smallest diameter of the flow-influencing element transverse to the longitudinal direction of the device or the direction of flow. Furthermore, the distance refers to the distance between the end of the flow-influencing element located in the main flow direction and the beginning of the measurement region or the contact surfaces located against the main flow direction.

Furthermore, the flowmeter can have two housing halves that can be moved in relation to one another, by means of which the flowmeter can be opened and closed. When the flowmeter is open, the flowmeter can be coupled to the measurement region in which the measurement region is arranged on a measurement region receptacle of the flowmeter. By closing the flowmeter, the measurement region is fixed in the flowmeter and in particular in the measurement region receptacle so that the sensor system of the flowmeter can contact the measurement region and in particular the contact surfaces. In particular, the flow measurement can be carried out when the flowmeter is closed.

A second aspect relates to a system having a device according to the first aspect and a flowmeter. Furthermore, the flowmeter can be designed as described above.

A third aspect relates to a method for detecting a measurement variable of the fluid conducted by a line, comprising:
arranging a device according to the first aspect on a fluid-conducting line,
arranging a flowmeter at the measurement region,
passing the fluid through the flow path, and
performing the flow measurement.

Furthermore, the flowmeter can be designed as described above.

Furthermore, the method can provide for the flow properties of a fluid flowing into the device through the first connection to be influenced by the flow-influencing element in such a manner that the fluid or medium has a turbulent flow in the measurement region.

A fourth aspect relates to the use of a device according to the first aspect for measuring the flow of a fluid.

Further features, details and advantages of the invention result from the following description and from the drawings, which show exemplary embodiments of the invention. Corresponding objects or elements are provided with the same reference signs in all figures. In the figures:

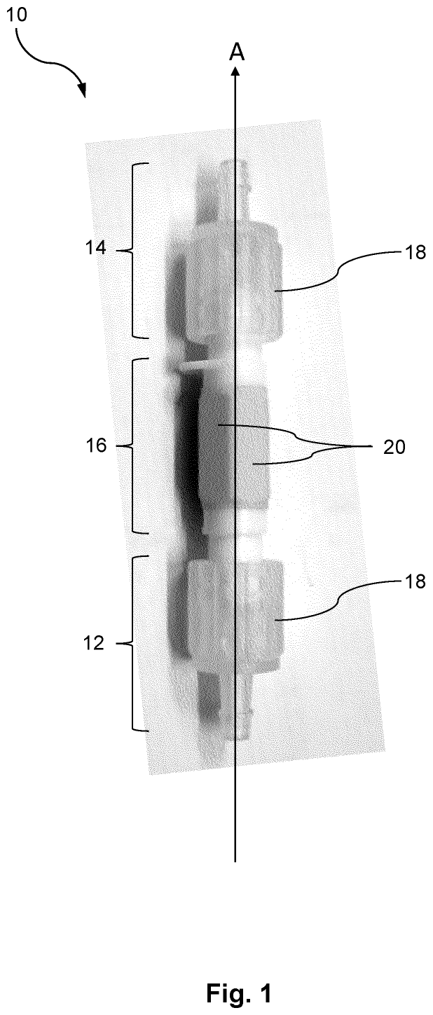

FIG. 1 shows a perspective view of a device for arranging on a fluid-conducting line and for attaching a flowmeter,

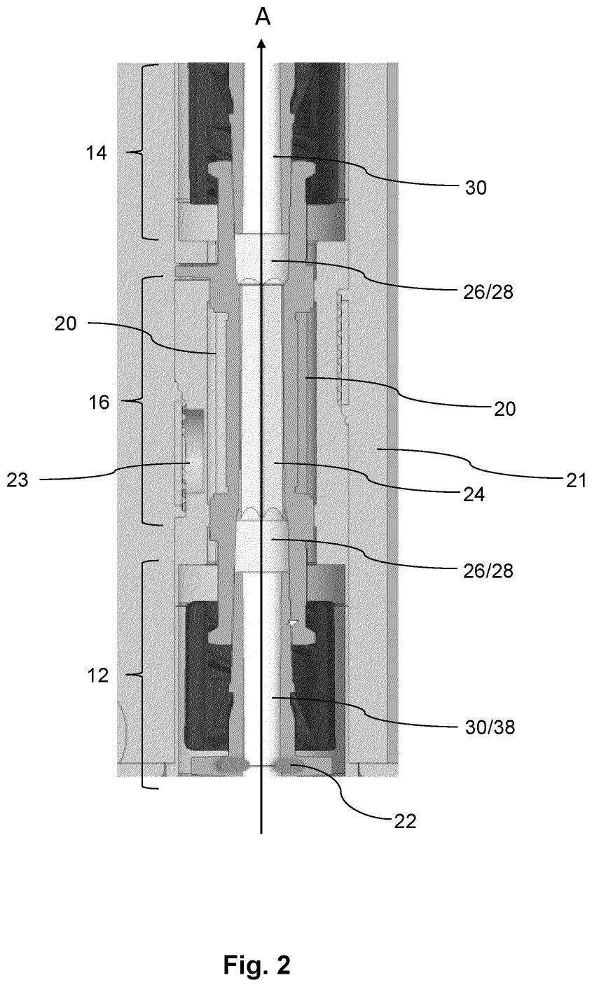

FIG. 2 shows a sectional view of the device,

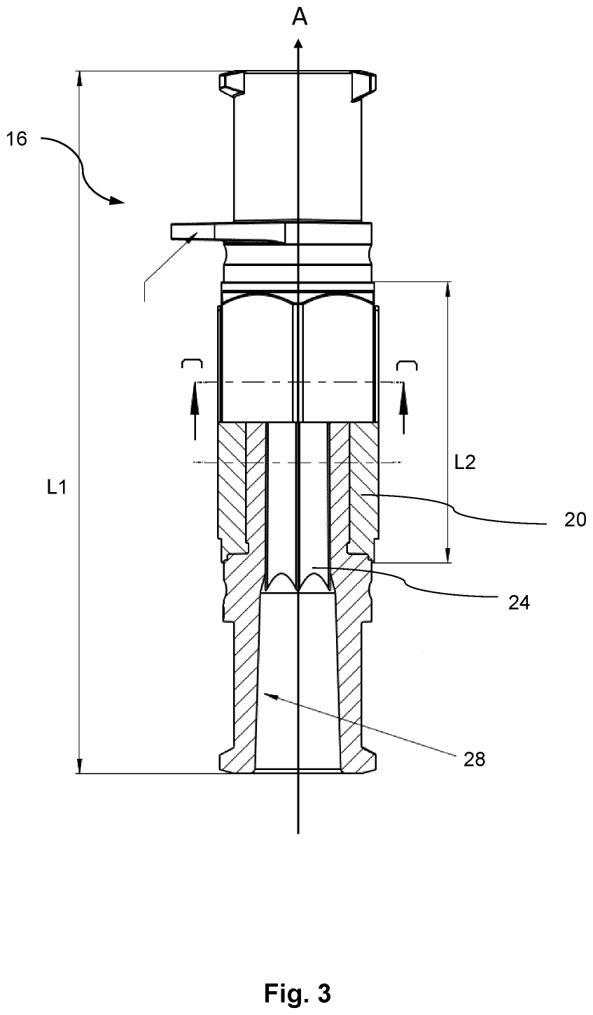

FIG. 3 shows the measurement region of the device,

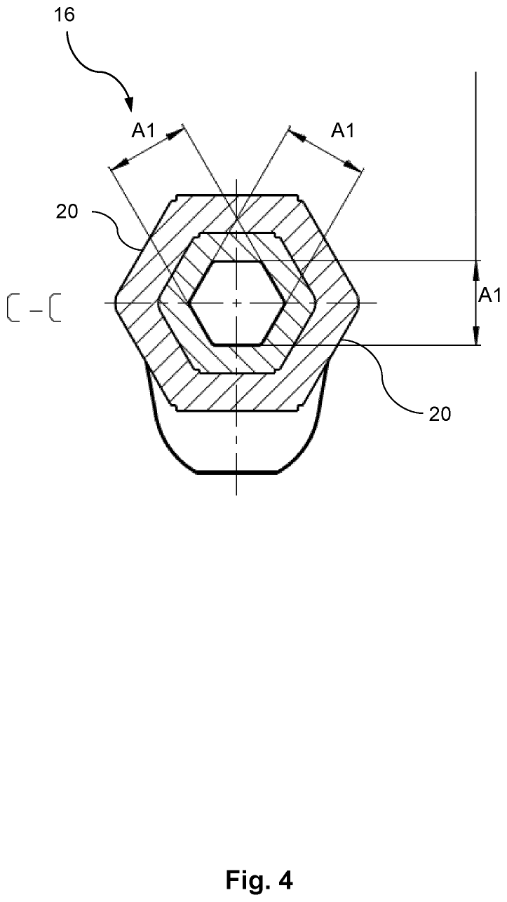

FIG. 4 shows a sectional view of the measurement region,

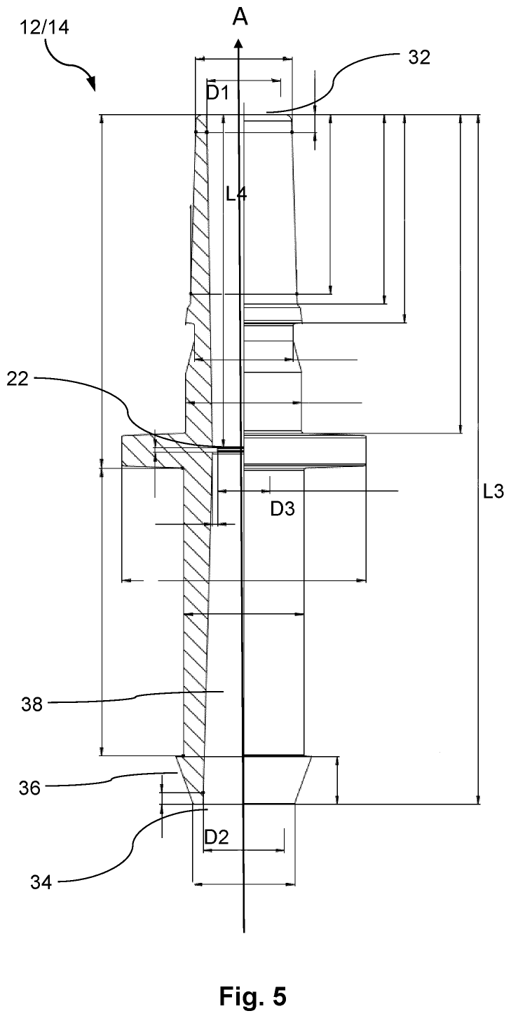

FIG. 5 shows a connection of the device,

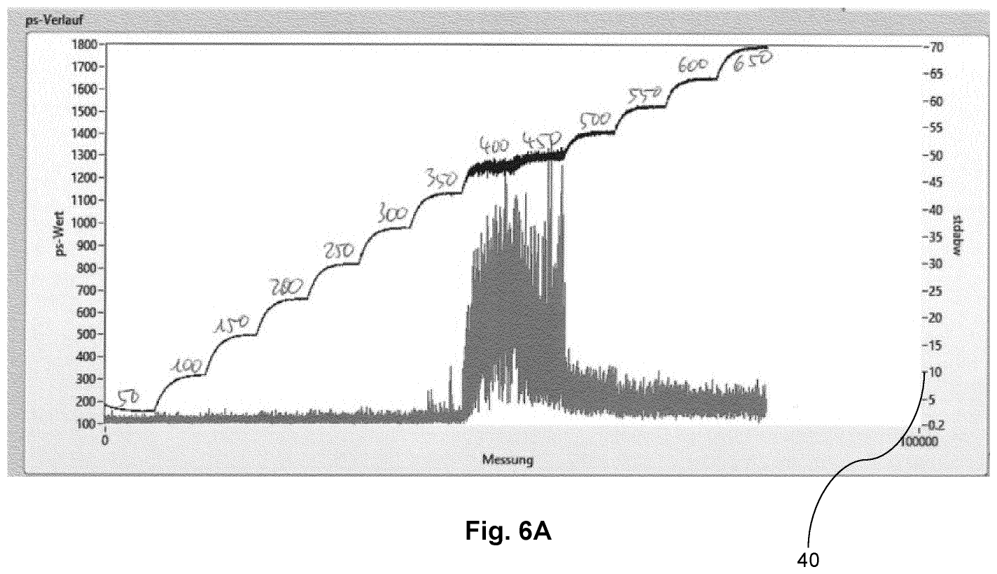

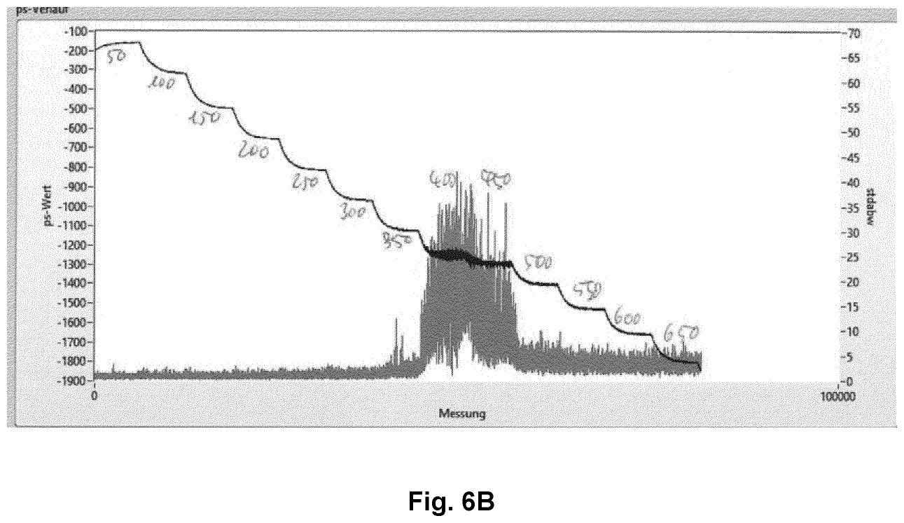

FIGS. 6A and 6B show measurement results with a conventional device,

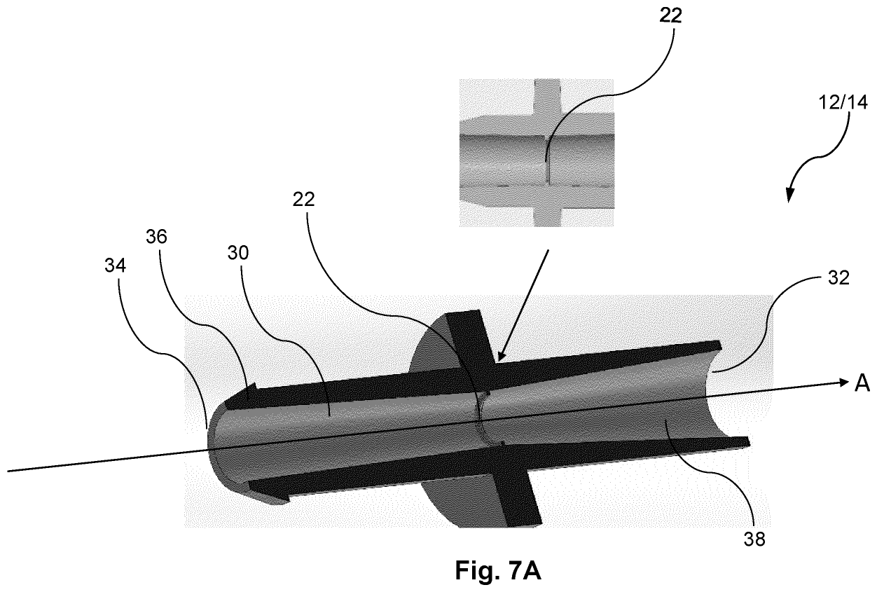

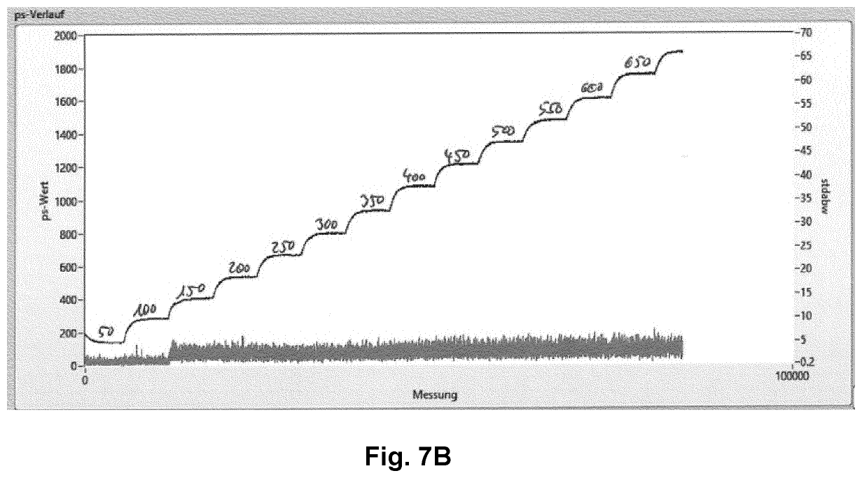

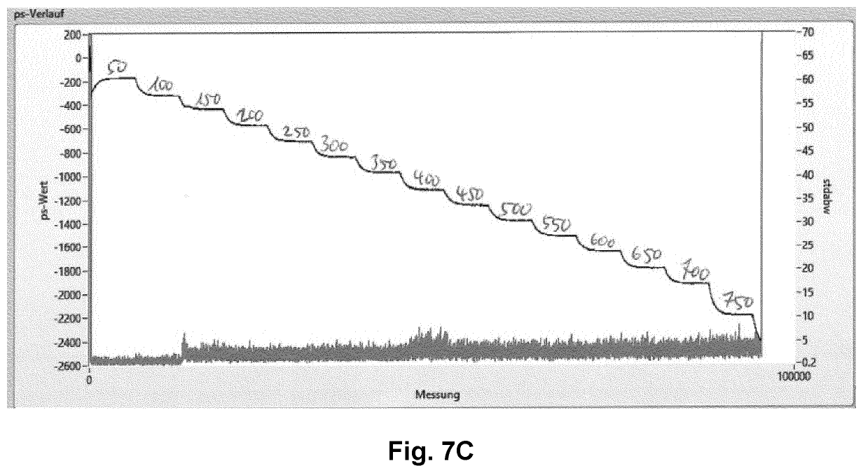

FIGS. 7A to 7C show a first design of a flow-influencing element and associated measurement results,

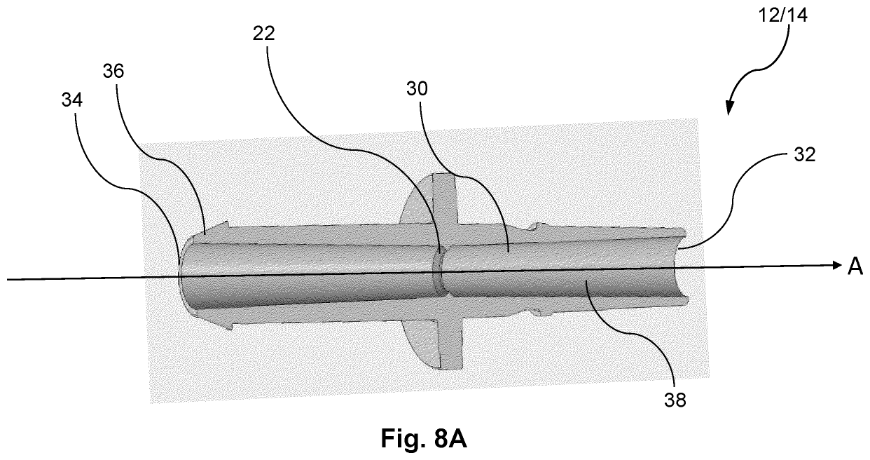

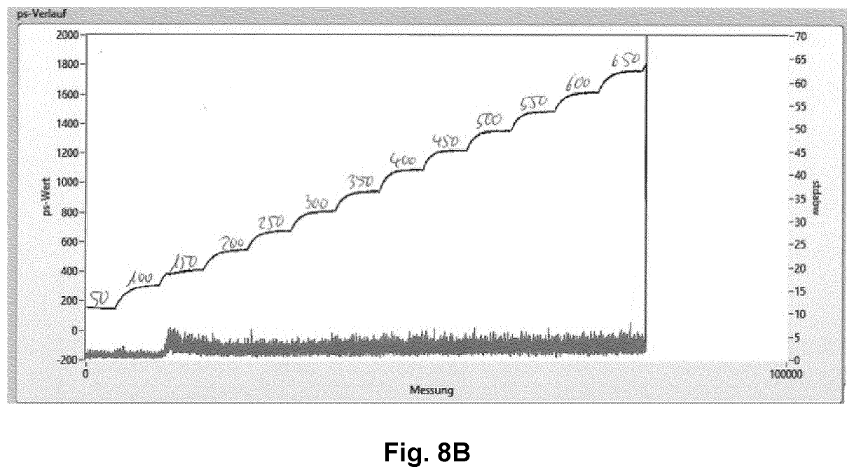

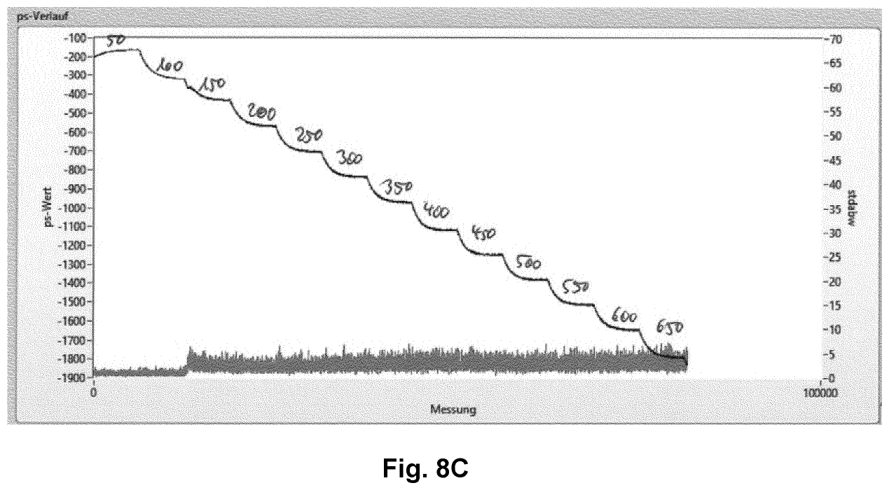

FIGS. 8A to 8C show a second design of a flow-influencing element and associated measurement results,

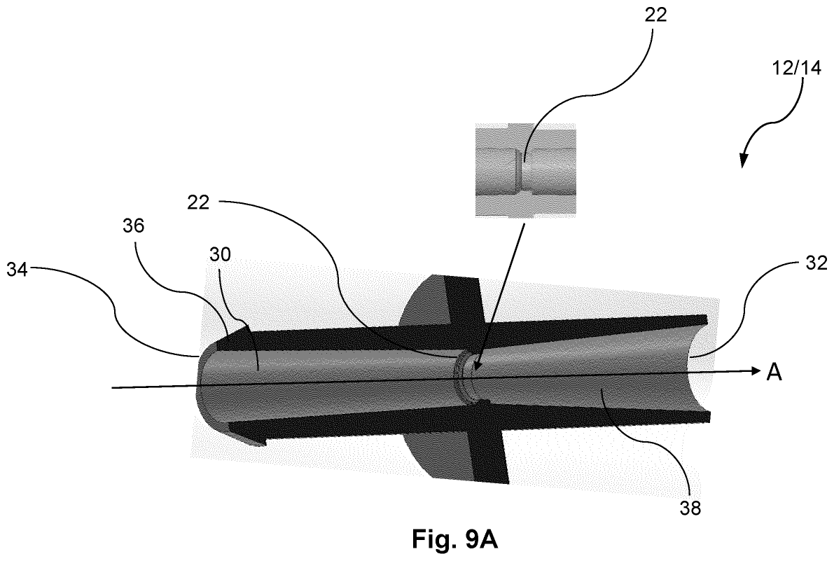

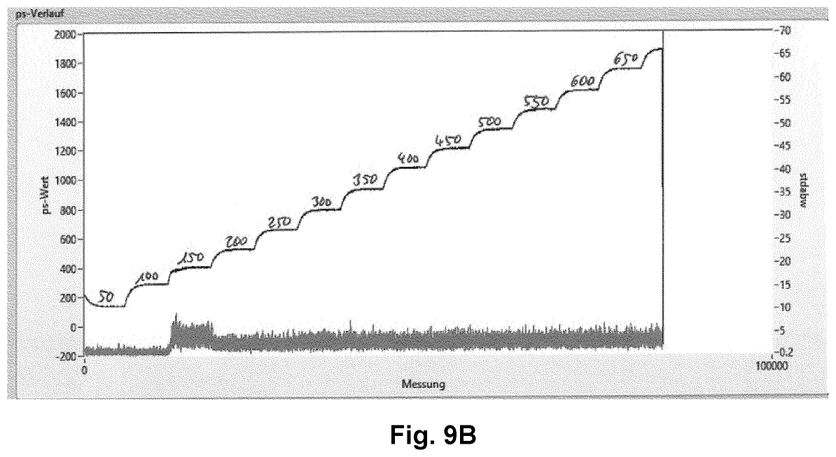

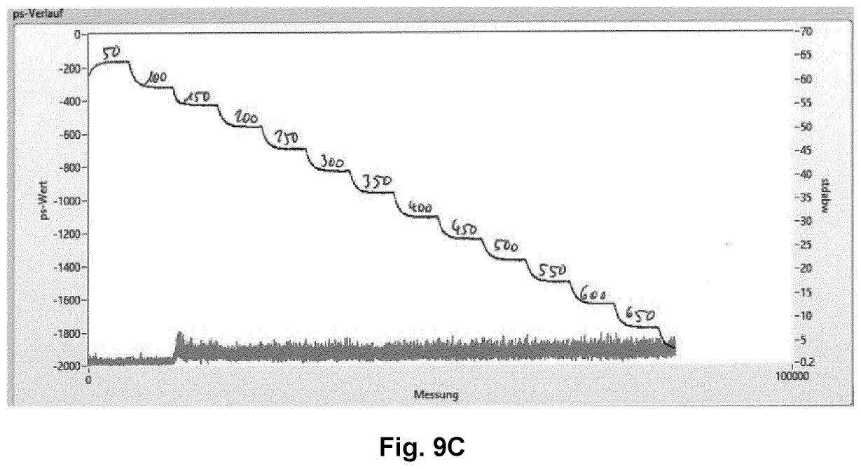

FIGS. 9A to 9C show a third design of a flow-influencing element and associated measurement results,

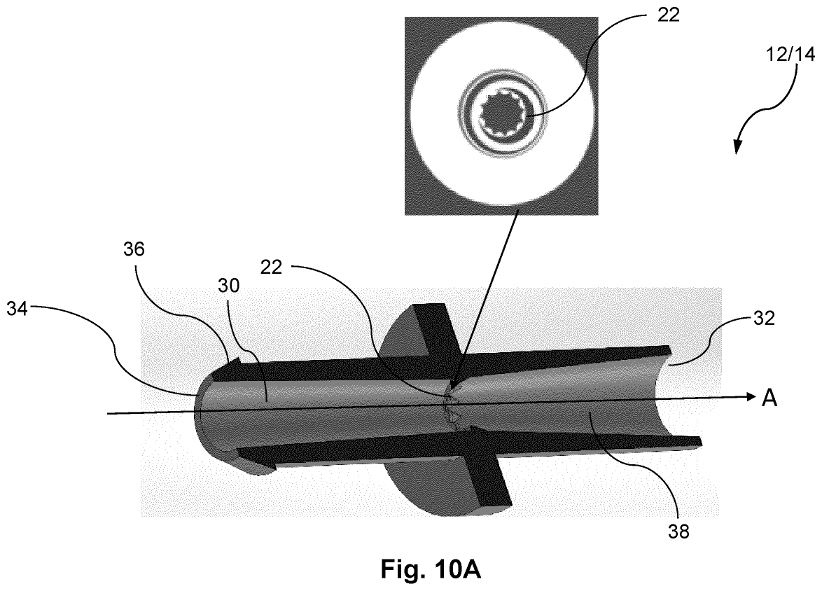

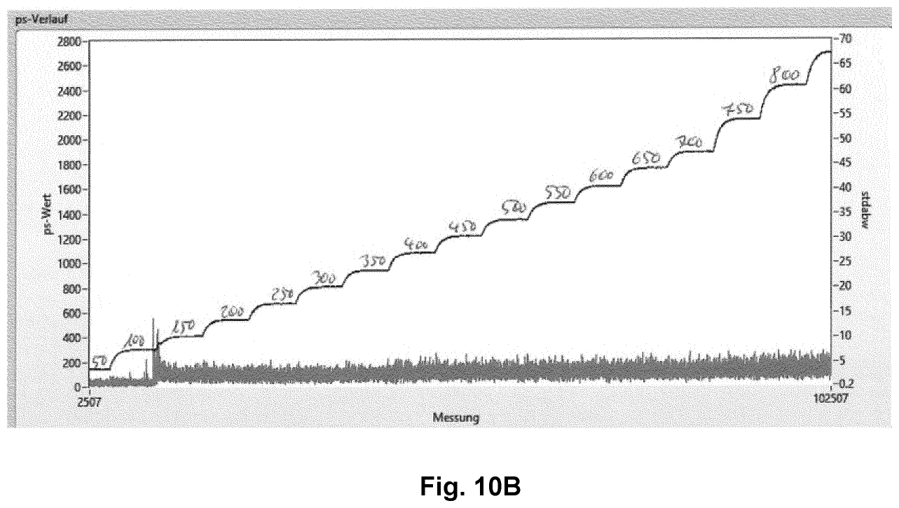

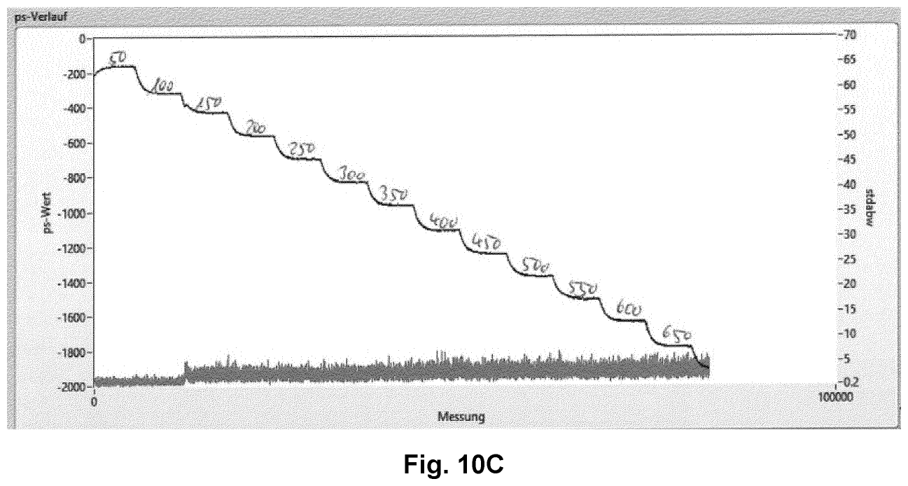

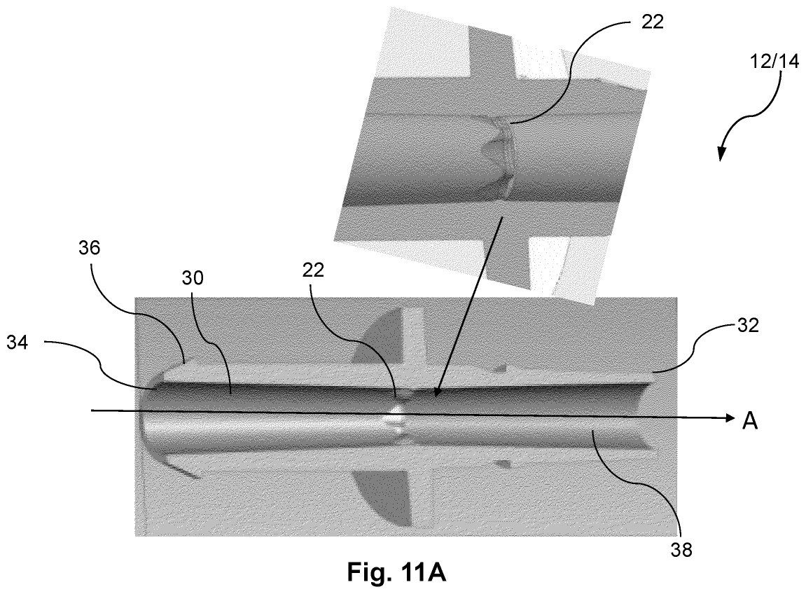

FIGS. 10A to 10C show a fourth design of a flow-influencing element and associated measurement results,

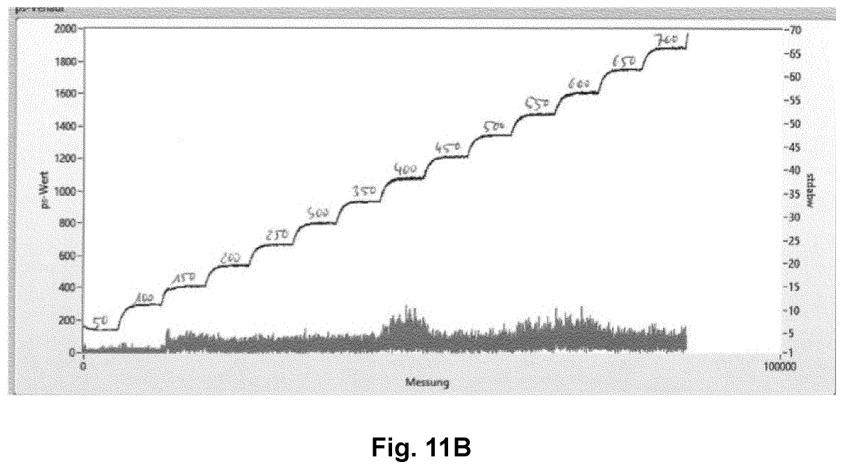

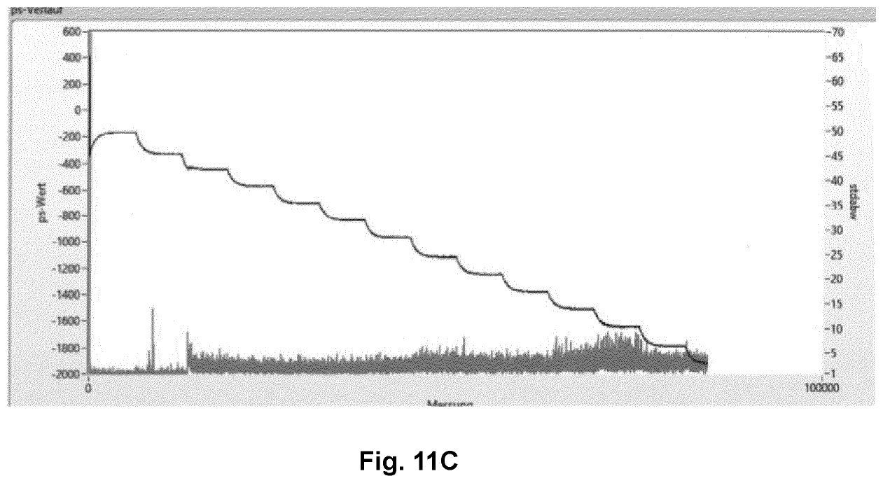

FIGS. 11A to 11C show a fifth design of a flow-influencing element and associated measurement results,

FIG. 1 shows a perspective view of a device 10 for arranging on a fluid-conducting line (not shown) and for attaching a flowmeter (not shown). The device 10 has a first and second connection 12/14, with which the device 10 can be arranged on a fluid-conducting line or between two fluid-conducting lines. A measurement region 16 is arranged between the first and second connections 12/14, at which the flowmeter can be arranged.

The first connection 12, the measurement region 16 and the second connection 14 define a flow path A through which a fluid or medium can flow through the device 10. For example, the first connection 12 can be connected to a fluid-conducting line, such as a plastic hose, wherein a fluid or medium can be supplied to the device 10 by means of the line. Furthermore, the second connection 14 can also be connected to a fluid-conducting line into which the fluid or medium flows from the device 10 via the second connection 14. In particular, it can be provided that the fluid is in liquid form, and solid particles, such as cell parts, can also be present in the fluid.

In particular, the first and second connections 12/14 and the measurement region 16 can form a channel 24/30 that defines the flow path A, wherein the fluid or medium can flow through the channel. In particular, the flow path A or the channel can be formed in an elongated manner. Preferably, the flow path A is substantially rectilinear, such that the main flow direction A of the fluid or medium through device 10 is substantially constant.

In the embodiment shown in FIG. 1, device 10 has a modular structure, wherein the first and second connections 12/14 can each be detachably connected to the measurement region 16. Securing elements 18 are provided for fastening or securing the first or second connection 12/14 to the measurement region 16. In the embodiment shown, the securing elements 18 are designed as union nuts with which the first and second connections 12/14 can be fastened to the measurement region 16.

The measurement region 16 has at least two contact surfaces 20, which extend at least in sections along the flow path A or the main flow direction A on the outside of the measurement region 16. Preferably, the contact surfaces 20 are arranged opposite one another with respect to the flow path A and in particular run parallel to one another. In the embodiment shown in FIG. 1, the measurement region 16 has six contact surfaces 20, which are arranged hexagonally. In particular, two opposite contact surfaces 20 form a contact surface pair, so that the measurement region 16 has three contact surface pairs.

As shown in the sectional view of device 10 shown in FIG. 2, device 10 has a flow-influencing element 22 arranged in or on the flow path A. The flow-influencing element 22 is arranged in front of the measurement region 16 in the main flow direction A and is designed such that a fluid or medium flowing into the device 10, said fluid flowing into the device 10 with a substantially laminar flow, has a substantially turbulent flow in the measurement region 16. By influencing the flow of the fluid or medium towards a turbulent flow, the measuring accuracy of the flow measurement can be improved. In the embodiment shown, the flow-influencing element 22 is formed on the inside of the channel 30 of the first connection 12 and can in particular extend into the flow path A, where it causes a narrowing of the cross-section of the flow path A. In particular, the flow-influencing element 22 can be formed in one piece with the first connection 12. It is also conceivable that the flow-influencing element 22 could be formed in one piece with the second connection 14.

The contact surfaces 20 can be coupled to the flowmeter 21 by arranging the flowmeter 21 at the measurement region 16. Furthermore, the flowmeter 21 may have a corresponding sensor system 23 with which the flowmeter 21 inputs an input signal, for example an ultrasonic signal, into the measurement region 16 via the contact surfaces 20 and receives an output signal based on the input signal. Based on a comparison of the input and output signal, a measurement variable of the fluid or medium flowing through the measurement region 16 can be determined.

FIG. 3 shows an example of an embodiment of the measurement region 16. The measurement region 16 is designed as an elongated hollow body and has a channel 24 that defines part of the flow path. A connection receptacle 28 is provided at each of the longitudinal ends 26 of the measurement region 16, each of which can receive a connection 12/14, such as the first connection 12 or the second connection 14. The contact surfaces 20 of the measurement region 16 are arranged between the connection receptacles 28.

As shown in FIG. 4, which shows a cross-section along the CC line through the measurement region 16 shown in FIG. 3, the six contact surfaces 20 are arranged hexagonally. The contact surfaces 20 are preferably rectangular in shape, wherein the longitudinal direction of the contact surfaces 20 runs substantially parallel to the main flow direction A of the fluid or medium through the device 10 or runs parallel to the longitudinal direction of the device. Furthermore, the inner cross-section of the measurement region 16, which is encompassed by the contact surfaces 20, is also hexagonal in shape.

Furthermore, FIG. 5 shows an example of a connection as it can be used, for example, as a first connection 12 and/or second connection 14. The connection 12/14 is designed as an elongated hollow body and has a channel 24 that defines part of the flow path. In particular, the connection 12/14 can be rotationally symmetrical to its longitudinal axis. A first end 32 (end on the measuring region side) lying in the longitudinal direction of the connection 12/14 can be designed to be received by the connection receptacle 28. A second end 34 (line-side end) of the connection 12/14, which is opposite the first end 32 in the longitudinal direction, can be designed to be connected to a line. In particular, the second end 34 may have a hose olive 36 or a hose spike 36 with which the line can be secured to the connection 12/14 or the device 10.

Furthermore, the connection 12/14 has the flow-influencing element 22, which is arranged substantially centrally in the connection 12/14 when viewed in the longitudinal direction A, and extends from wall 38 of the connection 12/14 surrounding the flow path A into the flow path A. Furthermore, the connection 12/14 has a substantially circular internal cross-section, wherein the cross-section of flow path A tapers from the first end 32 in the direction of the flow-influencing element 22 and from the second end 34 in the direction of the flow-influencing element 22, respectively. Furthermore, the cross-sectional area of the flow path A immediately in front of and after of the flow-influencing element 22 is larger than in the region of the flow-influencing element 22. In particular, flow path A, starting from each the first end 32 and the second end 34, can be designed to taper conically in the direction of the flow-influencing element 22.

With reference to FIGS. 6A to 11C, the effect of the flow-influencing element 22 and various embodiments of the flow-influencing element 22 are discussed below.

Here, FIGS. 6A and 6B show the standard deviation of a measurement signal for a conventional device that does not have a flow-influencing element 22 according to the invention. FIG. 6A shows the measurement signal for a positive flow direction, i.e. when the fluid or medium flows through the device 10 in the direction of the main flow direction A shown in FIG. 1, and FIG. 6B for an opposite flow direction. Here, at a volume flow of 400 to 450 ml/min, a nonlinear behavior of the flowmeter can be seen. Furthermore, the standard deviation of the measurement signal 40 shown indicates a strong signal noise at a volume flow of 400 to 450 ml/min.

FIGS. 7A to 7C relate to a first embodiment of the flow-influencing element 22. As shown in FIG. 7A, the flow-influencing element 22 is fully formed as an annular constriction on the inside of channel 30.

Compared to FIGS. 6A and 6B, the embodiment shown in FIG. 7A shows a significant improvement in flow measurement. FIGS. 7B and 7C show that the transition point from laminar flow to turbulent flow has shifted towards lower volume flows. The transition point is now 100-150 ml/min, both in the positive flow direction (FIG. 7B) and in the negative or opposite flow direction (FIG. 7C). Furthermore, the linearity in the region of the transition point has improved and the signal noise has been reduced by an order of magnitude.

In particular, the flow-influencing element 22 can be regarded as a constriction if its dimension in the longitudinal direction of the connection 12/14 is smaller or approximately the same size as the dimension with which the flow-influencing element 22 projects into the flow path A from the inside of channel 30. Preferably, the cross-sectional area of the flow path A of the flow-influencing element 22 may be approximately 6% to 20%, preferably approximately 8% to 15%, in particular approximately 8.5% to 12%, smaller than the cross-sectional area of the flow path A immediately in front of and preferably immediately after the flow-influencing element 22. Furthermore, flow path A may be characterized by a sharp transition to and from the flow-influencing element 22.

Preferably, the flow-influencing element 22 is arranged substantially centrally in the longitudinal extension of the connection 12/14. In the context of the present disclosure, an arrangement of the flow-influencing element 22 in the region of at most +/−15%, preferably at most +/−10%, of the length of the connection 12/14 around the center point of the connection 12/14 in the longitudinal direction thereof is considered to be substantially central.

Furthermore, the cross-sectional area of the flow path A in the region of the flow-influencing element 22 may be reduced by at least approximately 40%, preferably by at least approximately 45%, compared to the cross-sectional area of the flow path at the first end 32 and/or second end 34 of the connection 12/14. In particular, the first and second ends 32/34 are seen as the longitudinally located beginning and the longitudinally located end of the connection 12/14, respectively.

FIGS. 8A to 8C refer to a second embodiment of the flow-influencing element 22, in which the constriction shown in the first embodiment is more pronounced. As shown in FIG. 8A, the flow-influencing element 22 is fully formed as an annular constriction on the inside of channel 30. In particular, the flow-influencing element 22 can be regarded as a constriction if its dimension in the longitudinal direction of the connection 12/14 is smaller or approximately the same size as the dimension with which the flow-influencing element 22 projects into the flow path A from the inside of channel 30. Compared to the flow-influencing element 22 shown in FIG. 7A, the flow-influencing element 22 shown in FIG. 8A has a reduced cross-sectional area. In other words, the flow-influencing element 22 extends from the inside of channel 39 further into the flow path A.

Compared to FIGS. 6A and 6B, the embodiment shown in FIG. 8A shows a significant improvement in flow measurement. FIGS. 8B and 8C show that the transition point from laminar flow to turbulent flow has shifted towards lower volume flows. The transition point is now 100-150 ml/min, both in the positive flow direction (FIG. 8B) and in the negative or opposite flow direction (FIG. 8C). Furthermore, the linearity in the region of the transition point has improved and the signal noise has been reduced by an order of magnitude.

Furthermore, the cross-sectional area of the flow path in the region of the flow-influencing element 22 may be reduced by at least approximately 50% compared to the cross-sectional area of the flow path at the first end 32 and/or second end 34 of the connection 12.

FIGS. 9A to 9C relate to a third embodiment of the flow-influencing element 22. As shown in FIG. 9A, the flow-influencing element 22 is fully formed as an annular profile on the inside of channel 30. Preferably, the flow-influencing element 22 is arranged substantially centrally in the longitudinal extension of the connection 12/14. In the context of the present disclosure, an arrangement of the flow-influencing element 22 in the region of at most +/−15%, preferably at most +/−10%, of the length of the connection 12/14 around the center of the longitudinal extension of the connection 12/14 is considered to be substantially central.

In particular, the flow-influencing element 22 can be regarded as a profile if its dimension in the longitudinal direction of the connection 12/14 is greater than the dimension with which the flow-influencing element 22 projects into the flow path from the inside of channel 30. Preferably, the dimension of the flow-influencing element 22 in the longitudinal direction of connection 12/14 is at least twice as large as the dimension with which the flow-influencing element 22 projects into flow path A from the inside of channel 30.

Compared to FIGS. 6A and 6B, the embodiment shown in FIG. 9A shows a significant improvement in flow measurement. FIGS. 9B and 9C show that the transition point from laminar flow to turbulent flow has shifted towards lower volume flows. The transition point is now 100-150 ml/min, both in the positive flow direction (FIG. 9B) and in the negative or opposite flow direction (FIG. 9C). Furthermore, the linearity in the region of the transition point has improved and the signal noise has been reduced by an order of magnitude.

Furthermore, the cross-sectional area of the flow path A in the region of the flow-influencing element 22 may be reduced by at least approximately 40%, preferably by at least approximately 45%, compared to the cross-sectional area of the flow path A at the first end 32 and/or second end 34 of the connection 12. In particular, the first and second ends 32/34 are seen as the longitudinally located beginning and the longitudinally located end of the connection 12/14, respectively.

FIGS. 10A to 10C relate to a fourth embodiment of the flow-influencing element 22. Similar to the first embodiment, the flow-influencing element 22 is fully formed as a constriction on the inside of channel 30, wherein the flow-influencing element 22 is additionally structured and has recesses, whereby the inner diameter of flow path A in the region of the flow-influencing element 22 is unequal at different angles about the longitudinal axis of connection 12/14. As can be seen from FIG. 10A, the structure of the flow-influencing element 22 is shaped like a crown cork when viewed in the longitudinal direction.

Compared to FIGS. 6A and 6B, the embodiment shown in FIG. 10A shows a significant improvement in flow measurement. FIGS. 10B and 10C show that the transition point from laminar flow to turbulent flow has shifted towards lower volume flows. The transition point is now 100-150 ml/min, both in the positive flow direction (FIG. 10B) and in the negative or opposite flow direction (FIG. 10C). Furthermore, the linearity in the region of the transition point has improved and the signal noise has been reduced by an order of magnitude.

Furthermore, the cross-sectional area of the flow path A in the region of the flow-influencing element 22 may be reduced by at least approximately 45% compared to the cross-sectional area of the flow path A at the first end 32 and/or second end 34 of the connection 12/14.

FIGS. 11A to 11C relate to a fifth embodiment of the flow-influencing element 22. Similar to the fourth embodiment, the flow-influencing element 22 is structured in the shape of a crown cork. Wherein the structuring in the longitudinal direction of connection 12/14 is formed more elongated than in the fourth embodiment. In particular, the dimension of the flow-influencing element 22 in the longitudinal direction of connection 12/14 can be at least three times greater than the dimension with which the flow-influencing element 22 projects from the inside of channel 30 into flow path A.

Compared to FIGS. 6A and 6B, the embodiment shown in FIG. 11A shows a significant improvement in flow measurement. FIGS. 11B and 11C show that the transition point from laminar flow to turbulent flow has shifted towards lower volume flows. The transition point is now 100-150 ml/min, both in the positive flow direction (FIG. 11B) and in the negative or opposite flow direction (FIG. 11C). Furthermore, the linearity in the region of the transition point has improved and the signal noise has been reduced by an order of magnitude.

Furthermore, the cross-sectional area of the flow path A in the region of the flow-influencing element 22 may be reduced by at least approximately 45% compared to the cross-sectional area of the flow path at the first end 32 and/or second end 34 of the connection 12.

With reference to FIGS. 3 to 5, an embodiment of device 10 is explained in more detail. For example, the measurement region 16 shown in FIG. 3 has a length L1 of 30 mm to 40 mm, preferably approximately 35 mm. Viewed in longitudinal direction A, the contact surfaces 20 are arranged centrally on the measurement region 16 and have a length L2 of between 10 mm and 14 mm. Furthermore, the connection receptacles 28 may have a length of 6 mm to 10 mm, so that the first and second connections 12/14 can be inserted into the connection receptacles 28 to a corresponding depth along the longitudinal direction A. Furthermore, opposite sides of the hexagonal inner cross-section (see FIG. 4) may have a distance A1 of between 3 mm and 3.4 mm, preferably approximately 3.18 mm, from one another. Furthermore, embodiments are conceivable which have a distance A1 of up to 9 mm.

The connection 12/14 shown in FIG. 5 may have a length L3 of 25 mm to 33 mm, preferably of approximately 28.8 mm. The diameter D1 of flow path A at the first end 32 on the measurement region side may be between 2.87 mm and 3.27 mm, preferably 3.07 mm. The diameter D2 of flow path A at the second end 34 on the line side may be between 3.17 mm and 3.57 mm, preferably 3.37 mm. In particular, the flow-influencing element 22 can be designed as a constriction (as described above).

The flow-influencing element 22 can project from the inside of channel 30 between 0.1 mm and 0.3 mm, preferably 0.2 mm, fully from the inside of channel 30 into flow path A. In particular, the diameter D3 of flow path A in the region of the flow-influencing element 22 can be between 2.0 mm and 2.4 mm, preferably approximately 2.2 mm. Furthermore, the flow-influencing element 22 can be spaced from the first end 32 on the measurement region side by a length L4 of 11.9 mm to 15.9 mm, preferably 13.9 mm.

### LIST OF REFERENCE SIGNS

10 Device for arranging on a fluid-conducting line
12 First connection
14 Second connection
16 Measurement region
18 Securing element
20 Contact surfaces
21 Flowmeter
22 Flow-influencing element
23 Sensor system
24 Channel of measurement region
26 End of measurement region
28 Connection receptacle
30 Channel of the connection
32 First end of connection (measurement region side)
34 Second end of connection (line side)
36 Hose olive or hose spike
38 Wall from connection
40 Standard deviation of measurement signal
A Flow path or main flow direction/longitudinal direction of the device

Further features, characteristics and advantages of the invention are described with reference to the following points:
1. A device for arranging on a fluid-conducting line and for attaching a flowmeter, in particular an ultrasonic flowmeter, for detecting a measurement variable of the fluid conducted by the line, wherein the device has:
a first and a second connection, by means of which the device can be connected to the fluid-conducting line,
a measurement region which is arranged between the first connection and the second connection and which can be coupled to the flowmeter in order to detect the measurement variable, wherein the first connection, the measurement region and the second connection define a flow path for the fluid through the device,
a flow-influencing element which is arranged in and/or on the flow path and which is arranged in front of the measurement region in a provided flow direction of the fluid along the flow path and at a distance therefrom, wherein the flow-influencing element is designed such that the fluid flowing into the device via the first connection, said fluid flowing into the device with a substantially laminar flow, has a substantially turbulent flow in the measurement region.
2. The device according to point 1, wherein the flow path along the first connection has at least in sections a substantially circular cross-section, and/or wherein the flow path along the second connection has at least in sections a substantially circular cross-section, and/or
wherein the flow path along the measurement region has at least in sections a substantially rectangular, in particular square, cross-section or a substantially hexagonal cross-section.
3. The device according to point 1 or 2, wherein the cross-sectional area of the flow path of the flow-influencing element is approximately 6% to 20%, preferably approximately 8% to 15%, in particular approximately 8.5% to 12%, smaller than the cross-sectional area of the flow path immediately in front of and preferably immediately after the flow-influencing element.
4. The device according to any of the preceding points, wherein the measurement region is spaced from the flow-influencing element in the flow direction by between 5 and 60 times the diameter of the flow-influencing element.
5. The device according to any of the preceding points, wherein the flow-influencing element is designed as a protrusion extending from a wall surrounding the flow path into the flow path.
6. The device according to any of the preceding points, wherein the flow-influencing element is designed as a substantially annular constriction, and wherein preferably the constriction is structured.
7. The device according to any of the preceding points, wherein the cross-sectional area of the flow path in front of and after the flow-influencing element, in particular immediately in front of and after the flow-influencing element, is larger than the cross-sectional area of the flow path in the region of the flow-influencing element.
8. The device according to any of the preceding points, wherein the first connection has a channel which forms at least part of the flow path, wherein the fluid flows in at a first end of the channel and the measurement region is arranged at a second end of the channel, and wherein the first connection has the flow-influencing element.
9. The device according to point 8, wherein the channel has at least in sections a substantially circular cross-section, wherein the cross-section tapers starting from the first end of the channel in the direction of the flow-influencing element, and wherein preferably the cross-section of the channel widens starting from the flow-influencing element in the direction of the second end of the channel.
10. The device according to any of the preceding points, wherein the first connection and/or the second connection are designed such that the fluid-conducting line can be arranged in a self-locking manner on the first connection and/or the second connection, wherein the first connection and/or the second connection are designed in particular as a hose olive.
11. The device according to any of the preceding points, wherein the measurement region has at least two contact surfaces which extend at least in sections along the flow path, wherein the contact surfaces can be coupled to the flowmeter.
12. The device according to any of the preceding points, wherein the first connection can be detachably connected to the measurement region, and/or wherein the second connection can be detachably connected to the measurement region.
13. The device according to any of the preceding points, wherein the first connection and/or the second connection can each be secured to the measurement region by a securing element.
14. A method for detecting a measurement variable of the fluid conducted by a line, comprising:
arranging a device according to any of points 1 to 13 on a fluid-conducting line, arranging a flowmeter at the measurement region,
passing the fluid through the flow path, and
performing the flow measurement.
15. A use of a device according to any of the preceding points 1 to 13 for measuring the flow of a fluid.

1.-15. (canceled)

16. A device for arranging on a fluid-conducting line and for attaching an ultrasonic flowmeter for detecting a measurement variable of the fluid conducted by the line, wherein the device comprises:
a first and a second connection, by means of which the device can be connected to the fluid-conducting line;
a measurement region which is arranged between the first connection and the second connection and which can be coupled to the flowmeter in order to detect the measurement variable, wherein the first connection, the measurement region and the second connection define a flow path for the fluid through the device; and
a flow-influencing element which is arranged in and/or on the flow path and which is arranged in front of the measurement region in a provided flow direction of the fluid along the flow path and at a distance therefrom,
wherein the flow-influencing element is integrally formed with the first connection or the second connection, and
wherein the flow-influencing element is configured so that the fluid flowing into the device via the first connection has a substantially laminar flow and a substantially turbulent flow in the measurement region.

17. The device according to claim 16, wherein the flow path along the first connection has at least in sections a substantially circular cross-section, and/or
wherein the flow path along the second connection has at least in sections a substantially circular cross-section, and/or
wherein the flow path along the measurement region has at least in sections a substantially rectangular or a substantially hexagonal cross-section.

18. The device according to claim 16, wherein the cross-sectional area of the flow path of the flow-influencing element is approximately 6% to 20% smaller than the cross-sectional area of the flow path immediately in front of and immediately after the flow-influencing element.

19. The device according to claim 16, wherein the cross-sectional area of the flow path of the flow-influencing element is approximately 8% to 15% smaller than the cross-sectional area of the flow path immediately in front of and immediately after the flow-influencing element.

20. The device according to claim 16, wherein the cross-sectional area of the flow path of the flow-influencing element is approximately 8.5% to 12% smaller than the cross-sectional area of the flow path immediately in front of and immediately after the flow-influencing element.

21. The device according claim 16, wherein the measurement region is spaced from the flow-influencing element in the flow direction by between 5 and 60 times the diameter of the flow-influencing element.

22. The device according to claim 16, wherein the flow-influencing element comprises a protrusion extending from a wall surrounding the flow path into the flow path.

23. The device according to claim 16, wherein the flow-influencing element is designed as a substantially annular constriction.

24. The device according to claim 16, wherein the cross-sectional area of the flow path in front of and after the flow-influencing element is larger than the cross-sectional area of the flow path in the region of the flow-influencing element.

25. The device according to claim 16, wherein the first connection has a channel which forms at least part of the flow path,
wherein the fluid flows in at a first end of the channel and the measurement region is arranged at a second end of the channel, and
wherein the first connection has the flow-influencing element.

26. The device according to claim 25, wherein the channel has at least in sections a substantially circular cross-section, wherein the cross-section tapers starting from the first end of the channel in the direction of the flow-influencing element, and wherein the cross-section of the channel widens starting from the flow-influencing element in the direction of the second end of the channel, and/or
wherein the channel of the first connection is conically tapered starting from the first end of the channel in the direction of the flow-influencing element, and wherein the channel of the first connection is conically tapered starting from the second end of the channel in the direction of the flow-influencing element.

27. The device according to claim 16, wherein the first connection and/or the second connection are configured so that the fluid-conducting line can be arranged in a self-locking manner on the first connection and/or the second connection.

28. The device according to claim 27, wherein the first connection and/or the second connection are configured as a hose olive.

29. The device according to claim 16, wherein the measurement region has at least two contact surfaces which extend at least in sections along the flow path, wherein the contact surfaces can be coupled to the flowmeter.

30. The device according to claim 16, wherein the first connection can be detachably connected to the measurement region, and/or wherein the second connection can be detachably connected to the measurement region.

31. The device according to claim 16, wherein the first connection and/or the second connection can be secured to the measurement region by means of a securing element.

32. A method for detecting a measurement variable of a fluid conducted by a line, comprising:
arranging a device according to claim 16 on a fluid-conducting line;
arranging a flowmeter at the measurement region;
passing the fluid through the flow path; and
performing the flow measurement.

33. A use of a device according to claim 16 for measuring the flow of a fluid.
